(19) United States
(12) Patent Application Publication
(10) Pub. No.: US 2017/0025901 A1
(43) Pub. Date: Jan. 26, 2017

(54) LOW POWER INDUCTIVE POWER RECEIVER

(71) Applicant: PowerbyProxi Limited, Auckland (NZ)

(72) Inventor: Lawrence Bernardo DELA CRUZ, Auckland (NZ)

(21) Appl. No.: 15/301,146

(22) PCT Filed: Apr. 2, 2014
(86) PCT No.: PCT/NZ2014/000056

§ 371 Date: Sep. 30, 2016

(51) Int. Cl. H02J 50/12; H02J 50/90

(52) U.S. Cl. CPC H02J 50/12; H02J 50/90

(57) ABSTRACT

An inductive power receiver including a receiving coil, first capacitor and power conditioning circuitry for providing power to a load. The inductive power receiver also includes a variable capacitance and/or a variable inductance connected in parallel with at least one of the receiving coil and the first capacitor. The variable capacitance includes a variable impedance and a second capacitor having a capacitance at least twice the capacitance of the first capacitor. The variable inductance includes a variable impedance and an inductor having an inductance at least twice the inductance of the receiving coil. A control circuit controls the variable impedance based on a load voltage input and a reference voltage input so as to regulate the power provided to the load.

### FIELD OF THE INVENTION

This invention relates generally to an inductive power receiver for use in inductive power transfer (IPT) systems. More particularly, but not exclusively, the invention relates to an inductive power receiver suitable for use in lower power IPT systems.

### BACKGROUND OF THE INVENTION

IPT technology is an area of increasing development and IPT systems are now utilised in a range of applications and with various configurations. Typically, a primary side (i.e. an inductive power transmitter) will include a transmitting coil or coils adapted to generate an alternating magnetic field. This magnetic field induces an alternating current in the receiving coil or coils of a secondary side (i.e. an inductive power receiver). This induced current in the receiver can then be provided to some load, for example for charging a battery or powering a portable device. In some instances, the transmitting coil(s) or the receiving coil(s) may be suitably connected with capacitors to create a resonant circuit. This can increase power throughput and efficiency at the corresponding resonant frequency.

A problem associated with IPT systems is regulating the amount of power provided to the load. It is important to regulate the power provided to the load to ensure the power is sufficient to meet the load's power demands. Similarly, it is important that the power provided to the load is not excessive, which may lead to inefficiencies.

Typically, receivers used in IPT systems consist of: a pickup circuit (e.g. a resonant circuit in the form of an inductor and capacitor); a rectifier for converting the induced power from AC to DC; and a switched-mode regulator for regulating the voltage of the power ultimately provided to a load.

A problem associated with such switched-mode regulators is that they often need to include DC inductors (for example, as used in DC Buck converters). Such DC inductors can be relatively large in terms of volume. As there is demand to miniaturise receivers so that they may fit within portable electronic devices, it is desirable that the DC inductor be eliminated from the receiver circuitry. A further problem associated with using switched-mode regulators is that they may rely on complex control circuitry (including, for example, integrated circuits or controllers) to achieve the necessary switching. Such complex control circuitry may draw too much power resulting in quiescent losses, which—in the context of low power IPT systems—may exceed allowances and lead to inefficiencies.

Another approach to regulating power in an inductive power receiver is to adjust the tuning of the pickup circuit so as to compensate for changes in frequency of the transmitted power signal or the coupling between the transmitter and the receiver. For example, the Assignee's patent application PCT Publication No. WO2013/006068A1, the contents of which are incorporated herein by reference, discloses an inductive power receiver that includes a tunable pickup circuit. The effective impedance of a variable impedance connected in parallel with the receiving coil is controlled so as to regulate the tuning of the pickup circuit and thus the power supplied to an output.

In the tuning approach taught by WO2013006068A1 the variable impedance is able to accommodate relatively small changes in coupling between the transmitter and receiver.

Accordingly, an inductive power receiver is required for regulating the power provided to the load of an IPT system that includes simple control circuitry particularly suitable for low power applications, and/or an inductive power receiver that is able to regulate power for an increased range of couplings.

### SUMMARY OF THE INVENTION

According to one exemplary embodiment there is provided an inductive power receiver including: a resonant circuit having a receiving coil and a first capacitor; power conditioning circuitry for providing power from the resonant circuit to a load; a variable capacitance connected in parallel with at least one of the receiving coil and the first capacitor, with the variable capacitance including a second capacitor connected in series with a first variable impedance; and a control circuit for controlling the first variable impedance so as to regulate the power provided to the load, wherein the capacitance of the second capacitor is at least twice the capacitance of the first capacitor.

According to another exemplary embodiment there is provided an inductive power receiver including: a resonant circuit having a receiving coil and a capacitor; power conditioning circuitry for providing power from the resonant circuit to a load; a variable inductance connected in parallel with at least one of the receiving coil and the capacitor, with the variable inductance including a damping inductor connected in series with a first variable impedance; and a control circuit for controlling the first variable impedance so as to regulate the power provided to the load, wherein the inductance of the damping inductor is at least twice the inductance of the receiving coil.

According to a further exemplary embodiment there is provided an inductive power receiver including: a resonant circuit having a receiving coil and a capacitor; power conditioning circuitry for providing power from the resonant circuit to a load; a damping element connected in parallel or series with at least one of the receiving coil and the capacitor, wherein the damping element includes a first variable impedance; and a control circuit for controlling the first variable impedance so as to regulate the power provided to the load, wherein the control circuit includes a second variable impedance that provides a control signal output for controlling the first variable impedance based on a load voltage input and a reference voltage input

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a general representation of an inductive power transfer system according to one embodiment;

FIG. 2 shows a circuit diagram of an inductive power receiver according to one embodiment;

FIGS. 3a to 3d show circuit diagrams of an inductive power receiver according to further embodiments;

FIG. 4 shows a circuit diagram of an inductive power receiver according to another embodiment;

FIGS. 5a to 5d show circuit diagrams of an inductive power receiver according to further embodiments; and

FIG. 6 shows a circuit diagram of an inductive power receiver according to another embodiment.

### DETAILED DESCRIPTION OF EMBODIMENTS OF THE INVENTION

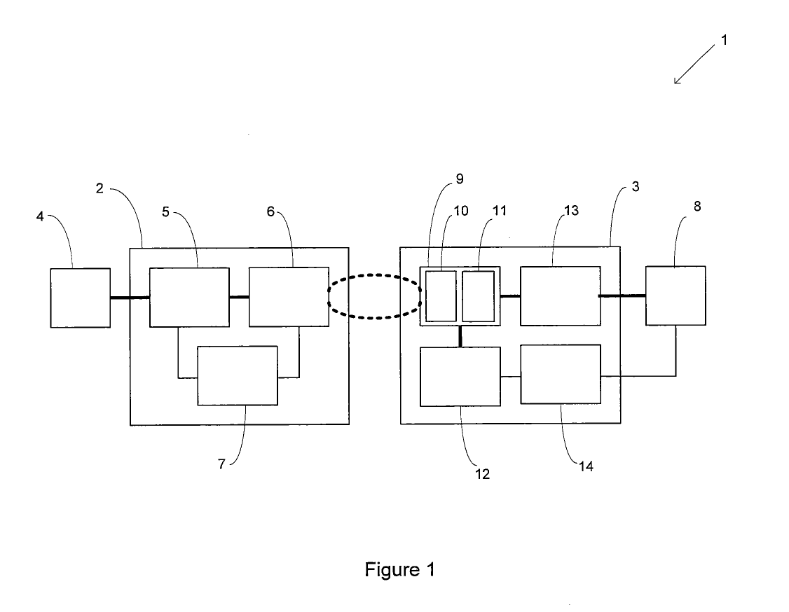

FIG. 1 is a block diagram showing a general representation of an inductive power transfer system 1. The IPT system includes an inductive power transmitter 2 and an inductive power receiver 3. In a particular embodiment, the IPT system may be a low power IPT system, where “low power” is considered to be less than about 10 W, for example, 2 W or less, or within the mW range, for example, about 100 mW to about 200 mW, depending on the application of the power transfer system.

The inductive power transmitter 2 is connected to an appropriate power supply 4 (such as mains power). The inductive power transmitter may include transmitter circuitry 5. Such transmitter circuitry includes any circuitry that may be necessary for the operation of the inductive power transmitter. Those skilled in the art will appreciate that this will depend upon the particular implementation of inductive power transmitter, and the invention is not limited in this respect. Without limiting its scope, transmitter circuitry may include converters, inverters, startup circuits, detection circuits and control circuits.

The transmitter circuitry 5 is connected to one or more transmitting (or primary) coils 6. The transmitter circuitry supplies the transmitting coil(s) with an alternating current such that the transmitting coil(s) generates a time-varying magnetic field with a selected frequency and amplitude. The selected frequency may be in the kHz range, or the MHz range, depending on the load application. Where the transmitting coil(s) is part of a resonant circuit, the frequency of the alternating current may be configured to correspond to the resonant frequency. Further the transmitter circuitry may be configured to supply power to the transmitting coil(s) having a desired current amplitude and/or voltage amplitude. In some lower power IPT systems, the power supplied to the transmitting coil(s) may be low such as below about 10 W (for example, about 2 W, or about 100 mW to about 200 mW depending on the required power of the receiver-side load).

The transmitting coil(s) 6 may be any suitable configuration of coils, depending on the characteristics of the magnetic field that are required in a particular application and the particular geometry of the transmitter. In some IPT systems, the transmitting coils may be connected to other reactive components, such as capacitors (not shown), to create a resonant circuit. Where there are multiple transmitting coils, these may be selectively energised so that only transmitting coils in proximity to suitable receiving coils are energised. In some IPT systems, it may be possible that more than one receiver may be powered simultaneously. In IPT systems, where the receivers are configured to regulate the power provided to the load (as, for example, in the embodiments of the present invention described in more detail later), the multiple transmitting coils may be connected to the same converter or inverter. This has the benefit of simplifying the transmitter as the need to control each transmitting coil separately is obviated. Further, it may be possible to configure the transmitter so that power provided to the transmitting coils is controlled to a level dependent on the coupled receiver with the highest power demands.

FIG. 1 also shows a controller 7 of the inductive power transmitter 2. The controller may be connected to each part of the inductive power transmitter. The controller may be configured to receive inputs from parts of the inductive power transmitter and produce outputs that control the operation of each part of the transmitter. Those skilled in the art will appreciate that the controller may be implemented as a single unit or separate units. The controller may be any suitable programmable controller, such as a micro-controller, that is configured and programmed to perform different computational tasks depending on the requirements of the inductive power transmitter. Alternatively, the controller may be implemented wholly or partially by discrete electrical components. Those skilled in the art will appreciate that the controller may control various aspects of the inductive power transmitter depending on its capabilities, including for example: power flow (such as setting the voltage supplied to the transmitting coil(s)), tuning of the operating frequency of the transmitter, selectively energising transmitting coils, inductive power receiver detection and/or communications.

As further shown in FIG. 1, the inductive power receiver 3 is connected to a load 8. As will be appreciated, the inductive power receiver is configured to receive inductive power from the inductive power transmitter 2 and to provide the received power to the load in some form. The load may be any suitable load depending upon the low power application for which the inductive power receiver is being used. For example, the load may be powering a portable electronic device or may be a rechargeable battery. The power demands of a load may vary, and therefore it is important that the power provided to the load matches the load's power demands in order to ensure efficient inductive power transfer and minimisation of undesired effects, such as overheating of the components of the receiver. Accordingly, the received power should be sufficient to meet the power demands of the load whilst not being excessive as this will lead to inefficiencies.

The receiver 3 includes a resonant circuit 9 that includes one or more receiving (or pick-up or secondary) coils 10 and one or more associated electrically reactive elements 11, such as one or more capacitors. Those skilled in the art understand that the combination of the inductive coil(s) and reactive element(s) provide a resonant frequency of operation of the resonant circuit. As will be appreciated, when the resonant frequency of the resonant circuit is substantially matched, or selectively tuned to be similar to, the operating frequency of the transmitter circuitry, the receiving coil will be suitably coupled to the transmitting coil 6 of the transmitter 2. Such coupling induces an AC voltage across the receiving coil resulting in AC current flow in the circuitry of the receiver, which is ultimately provided as received power to the load 8. The configuration of the receiving coil will vary depending on the characteristics of the particular IPT system for which the receiver is used, and the invention is not limited in this respect.

The receiver 3 includes a damping element 12. As will be described in more detail later, the damping element causes an adjustment in the amount of power received by the resonant circuit 9, thereby regulating the amount of power provided to the load 8.

The resonant circuit 9 of the receiver is connected to power conditioning circuitry 13. The conditioning circuitry is configured to condition power received by the resonant circuit, and to provide the conditioned power to the load 8. The conditioning circuitry may include power conditioning components, such as one or more of a rectifier, a smoothing capacitor, or other components with like function. For example, a rectifier may be configured to rectify the AC power of the resonant circuit to DC power that may be provided to the load 8. Those skilled in the art will appreciate that there are many types of rectifiers that may be applicable. In one embodiment, the rectifier may be a diode bridge. In another embodiment, the rectifier may include an arrangement of switches that may be actively controlled to provide synchronous rectification.

FIG. 1 further shows a control circuit 14 included in the inductive power receiver 3. The control circuit may be connected to each part of the inductive power receiver. The control circuit may be configured to receive inputs from parts of the inductive power receiver and produce outputs that control the operation of each part. In particular, the control circuit may control the damping element 12 as will be described in more detail later. The control circuit may be implemented as a single unit or separate collocated or distributed units. The control circuit may be any suitable programmable controller, such as a micro-controller, configured and/or programmed to perform different tasks depending on the requirements of the inductive power receiver. Alternatively, the control circuit may be implemented wholly or partially by discrete electrical components. Those skilled in the art will appreciate that the control circuit may control various aspects of the inductive power receiver depending on its capabilities, including for example: power flow, damping, conditioning and/or communications. According to a preferred embodiment that will be described in more detail later, the control circuit may be configured so as to minimise the number and/or complexity of components which have relatively significant power demands. However, in other embodiments, it may be possible to include more or less components of greater or lesser complexity, such as integrated circuit controllers in the control circuit.

The amount of power received by the inductive power receiver 3 will be dependent on:
the amount of power transmitted by the inductive power transmitter 2; and/or
the level of coupling between the transmitting coil(s) 6 and receiving coil(s) 10.

The amount of power transmitted by the inductive power transmitter may further depend on the tuning of the transmitting coil (if resonant) and/or the amplitude of the current supplied to the transmitting coil(s). The coupling between the transmitting coil(s) and receiving coil(s) may further depend on the alignment and distance between the transmitting coil(s) and receiving coil(s). For example, if the coils are close together, the coupling coefficient, k, will be closer to 1, whereas if the coils are separated by some distance, the coupling coefficient, k, will be closer to 0. As will be described in more detail later, the inductive power receiver of the present invention is configured to regulate the power provided to the load 8 in response to changes in the amount of power received by the inductive power receiver (for example, due to a change in the coupling coefficient between the transmitting coil(s) and receiving coil(s)).

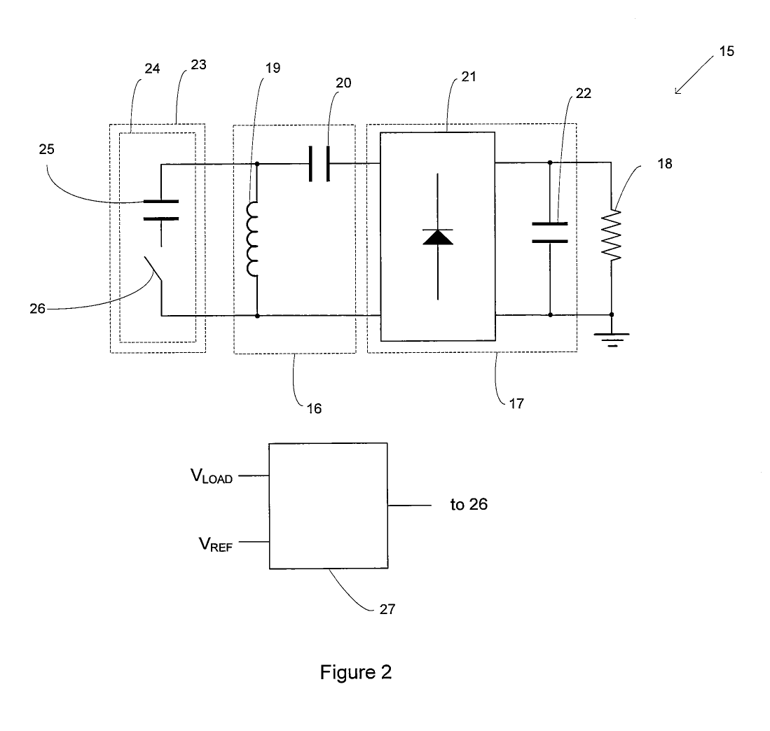

Having discussed the IPT system 1 in general, it is helpful to now discuss a particular embodiment of the inductive power receiver according to the present invention as shown in FIG. 2.

FIG. 2 shows an inductive power receiver 15. The inductive power receiver includes a resonant circuit 16 connected to power conditioning circuitry 17. The conditioning circuitry is further connected to a load 18, which is illustrated as a resistive element to depict the electrical nature of the load.

The resonant circuit 16 includes one or more receiving coils 19 connected with a resonating (or first) capacitor 20. In FIG. 2, the receiving coil is connected in series with the resonating capacitor. However, in other embodiments, it may be possible for the receiving coil to be connected in parallel with the resonating capacitor since it is the function of providing a resonant frequency of operation of the resonant circuit that is of import rather than the relative configuration of the elements of the resonant circuit. Further, whilst a single resonating capacitor is depicted, the capacitance of the resonating capacitor may be provided by several capacitors and/or a variable capacitor. In one embodiment, the resonant circuit is configured to have a resonant frequency that corresponds to the frequency of the power transmitted by the inductive power transmitter. In a preferred embodiment, the resonant circuit is configured to have a resonant frequency such that under relatively poor coupling (for example, due to a certain amount of distance or misalignment between the transmitting coil and receiving coil), sufficient power is still provided to the load 18.

The conditioning circuitry 17 provides power from the resonant circuit 16 to the load 18. In the illustrated embodiment, the conditioning circuitry includes a diode bridge rectifier 21 and a DC smoothing capacitor 22.

The inductive power receiver also includes a damping element 23. In this embodiment, the damping element 23 includes a variable capacitance 24 connected in parallel with the receiving coil 19. The variable capacitance includes a damping (or second) capacitor 25 connected in series with a variable impedance 26. The capacitance of the damping capacitor is selected so that the range of capacitances provided by the variable capacitance allows a capacitance of at least twice the capacitance of the resonating capacitor 20. In a preferred embodiment, the range of the variable capacitance allows a capacitance between five to ten times the capacitance of the resonating capacitor, as a capacitance higher than this causes the rise time of the power signal delivered to the load to increase thereby undesirably delaying power delivery. As will be explained in more detail later, selecting the capacitance of the damping capacitor to be larger than that of the resonating capacitor allows the inductive power receiver 15 to regulate the power to the load 18 over a relatively large range of power values.

The variable impedance 26 is controlled by a control circuit 27. The variable impedance may be any suitable element or device with an impedance that may be varied. In FIG. 2, the variable impedance is represented generally by a switch. The variable impedance may be a semiconductor device such as a transistor, for example a bipolar junction transistor (BJT) or a metal oxide semiconductor field effect transistor (MOSFET). Those skilled in the art will appreciate how the topology of FIG. 2 may need to be configured to operate with the various applicable types of variable impedances (for example, due to the polarity of the transistor), accordingly, in FIG. 2 the control circuit 27 is depicted without direct connection to the variable impedance 26, as the present invention is not limited in this respect.

The control circuit 27 controls the variable impedance 26 so as to vary the impedance, thus controlling the effective capacitance of the variable capacitance 24. The variable impedance is preferably controlled in linear mode (i.e. in an Ohmic region of operation) resulting in a continuous range of impedances. In another embodiment, the variable impedance may be controlled in either ‘hard’ or ‘soft’ switch mode such that the variable impedance is either fully on or fully off (with various degrees of control on the transition there between), with the respective proportion of time the variable impedance is in either of these states being controlled so as to give a range of effective impedances.

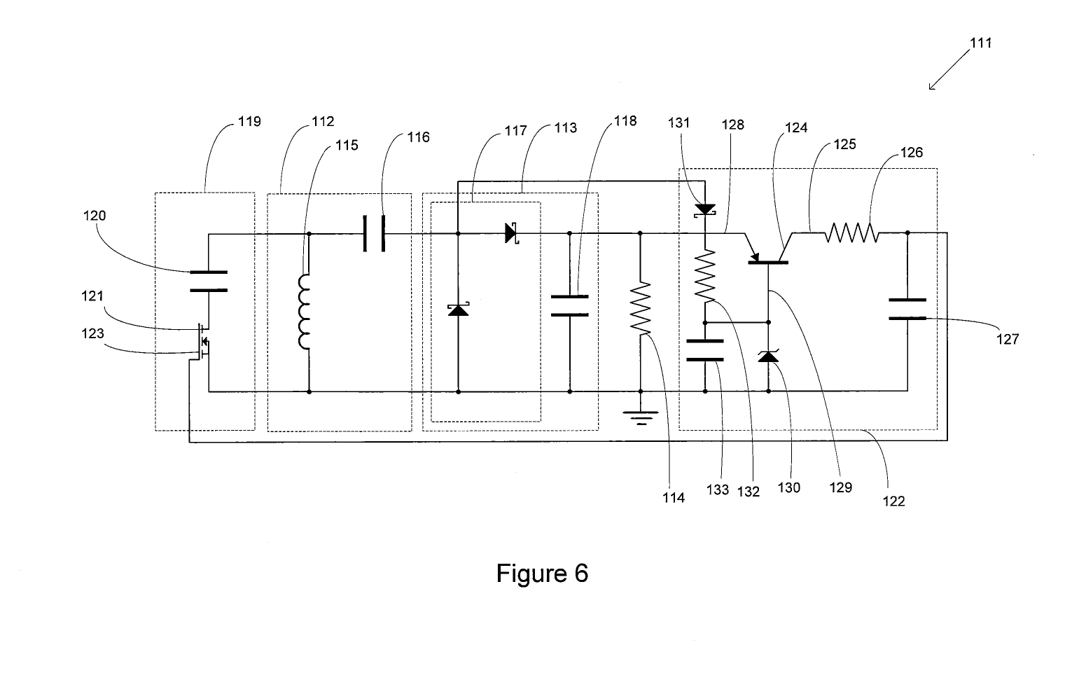

The control circuit 27, which is represented by a block in FIG. 2, is configured to provide a control signal to control the variable impedance. The controller has inputs, for example VREF and VLOAD from which the control signal is derived. A specific embodiment of the control circuit and the manner in which the control signal is provided will be discussed later with reference to FIG. 6.

Having generally discussed the components of FIG. 2, it is helpful to consider an exemplary operation of the inductive power receiver 15 with respect to the power flow control to the load 18. As discussed earlier, the resonant circuit 16 may be configured to pick up sufficient power for the particular load despite relatively poor coupling between the receiving coil(s) 19 and the transmitting coil(s). For example, the system 1 of the present invention is configured so that sufficient power is provided if the coupling between the receiving coil(s) and transmitting coil(s) has a coupling coefficient, k, less than 0.5, and even less than 0.1, e.g., about 0.08. Such poor coupling may be due to misalignment of the coils or non-ideal distance between the coils. This is achieved by suitable selection of the values of the components of the receiver, e.g., the inductive value of the receiving coil(s) and the capacitance value of the resonating capacitor, relative to the transmitted power value at the coupling coefficient deemed as the minimum coupling coefficient to be supported by the system and the power required by the receiver-side load, and then controlling the variable impedance 26 to be fully switched off by default, so that the variable capacitance 24 has no effect on the power picked up by the resonant circuit, and therefore no effect on the power provided to the load 18, when there is poor coupling. An example of the suitable selection of component values is discussed later with reference to FIG. 6.

If the coupling is caused to improve (for example, due to the distance between the receiving and transmitting coils being brought closer to ideal), the amount of power picked up by the resonant circuit 16 increases. If the default state of the damping element is maintained in this improved coupling condition excessive power will be received by the receiver which will result in either too much power being provided to the load or the excess power being dissipated by the receiver circuitry in the form of heat. This is circumvented by configuring the control circuit 27 to detect this increase in received power and control the variable impedance 26 to be switched on, either immediately or gradually, which introduces the impedance presented by the variable impedance into the circuit. This introduces the effective capacitance of the variable capacitance 24 into the circuit which dampens the resonant circuit 16 so that it picks up less power thereby regulating the amount of power delivered to the load. Effectively, the variable capacitance detunes the resonant circuit, and the amount of detuning is controlled by the value of the variable capacitance.

Accordingly, if the degree of coupling is increased further to ideal (e.g., the distance between the receiving and transmitting coils is brought closer to zero), the control circuit is able to control the switching of the variable impedance so as to increase the effective capacitance of the variable capacitance to maximally dampen the resonant circuit based on the achievable capacitance value of the variable capacitance. Depending upon the specific application, the range of couplings supported by the system may be required to be maximised, i.e., from poorest to ideal coupling, however a lesser range can be provided whilst still providing enhanced operation and capabilities. For example, by selecting a damping capacitor with a capacitance that is at least twice the capacitance of the resonating capacitor, the variable capacitance is able to be varied over a relatively large range and consequently dampen the resonant circuit over a relatively large range of couplings. An exemplary configuration of the control circuit which provides these functions of detection and control is discussed in detail later with reference to FIG. 6.

In the embodiment of the inductive power receiver discussed in relation to FIG. 2, the damping element 23 includes a single variable capacitance connected in parallel with the receiving coil 19. However, those skilled in the art will appreciate that it may be possible to configure the damping element to include more than one variable capacitance and/or to connect each variable capacitance across different points of the resonant circuit.

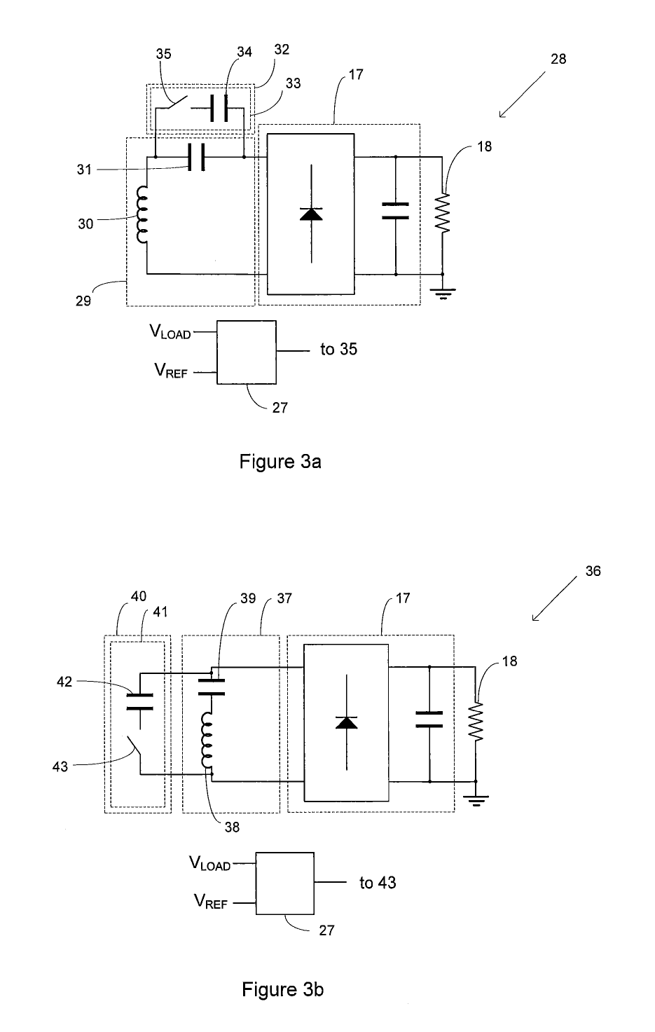

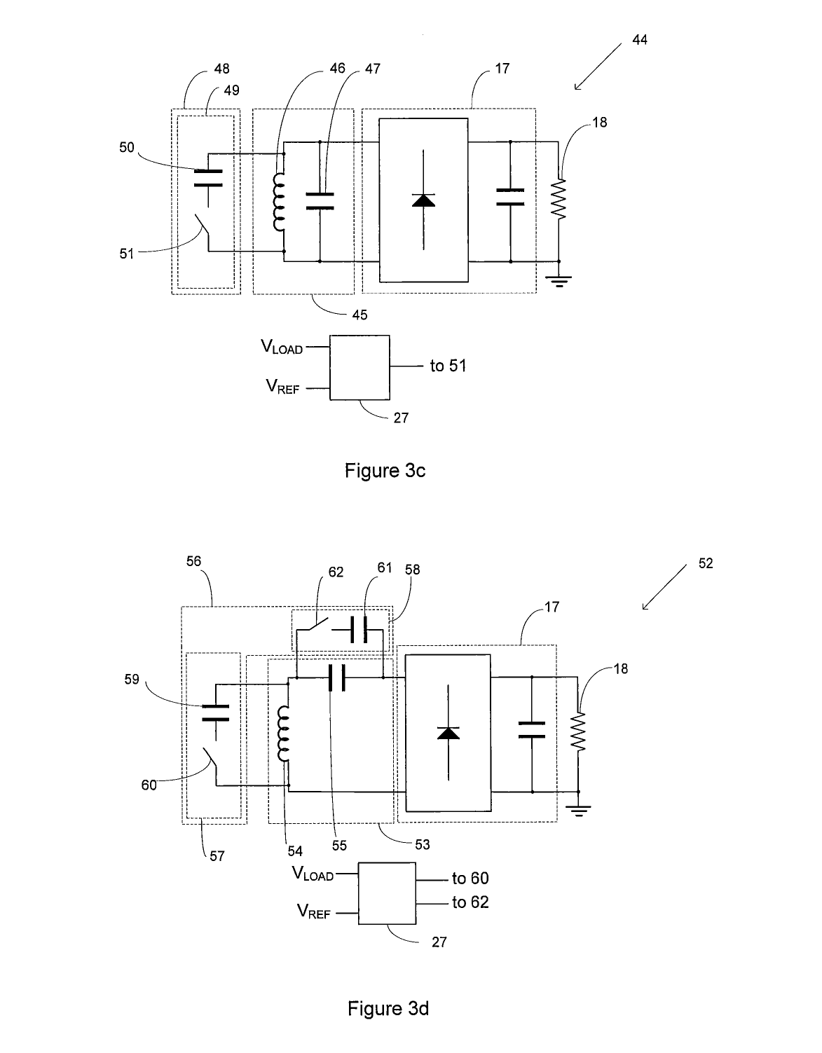

FIGS. 3a to 3d show some possible variations of the inductive power receiver 15 discussed in relation to FIG. 2. For the sake of comparison, the conditioning circuitry 17, load 18 and control circuit 27 have not been changed between each embodiment. Those skilled in the art will appreciate how the discussion of FIG. 2 may be adapted to relate to the topologies of FIGS. 3a to 3d.

In FIG. 3a, the inductive power receiver 28 includes a resonant circuit 29 having a receiving coil 30 connected in series with a resonating capacitor 31. A damping element 32 includes a variable capacitance 33 connected in parallel with the resonating capacitor. The variable capacitance includes a damping capacitor 34 connected in series with a variable impedance 35. The capacitance of the damping capacitor is at least twice the capacitance of the resonating capacitor. In a preferred embodiment, the capacitance of the damping capacitor is between five and ten times the capacitance of the resonating capacitor.

In FIG. 3b, the inductive power receiver 36 includes a resonant circuit 37 having a receiving coil 38 connected in series with a resonating capacitor 39. A damping element 40 includes a variable capacitance 41 connected in parallel with the receiving coil and resonating capacitor. The variable capacitance includes a damping capacitor 42 connected in series with a variable impedance 43. The capacitance of the damping capacitor is at least twice the capacitance of the resonating capacitor. In a preferred embodiment, the capacitance of the damping capacitor is between five and ten times the capacitance of the resonating capacitor.

In FIG. 3c, the inductive power receiver 44 includes a resonant circuit 45 having a receiving coil 46 connected in parallel with a resonating capacitor 47. A damping element 48 includes a variable capacitance 49 connected in parallel with the receiving coil and resonating capacitor. The variable capacitance includes a damping capacitor 50 connected in series with a variable impedance 51. The capacitance of the damping capacitor is at least twice the capacitance of the resonating capacitor. In a preferred embodiment, the capacitance of the damping capacitor is between five and ten times the capacitance of the resonating capacitor.

In FIG. 3d, the inductive power receiver 52 includes a resonant circuit 53 having a receiving coil 54 connected in series with a resonating capacitor 55. A damping element 56 includes a first variable capacitance 57 connected in parallel with the receiving coil and a second variable capacitance 58 connected in parallel with the resonating capacitor. The first variable capacitance includes a first damping capacitor 59 connected in series with a first variable impedance 60. The second variable capacitance includes a first damping capacitor 61 connected in series with a second variable impedance 62. The capacitance of the first damping capacitor and second damping capacitor is at least twice the capacitance of the resonating capacitor. In a preferred embodiment, the capacitance of the first damping capacitor and second damping capacitor is between five and ten times the capacitance of the resonating capacitor.

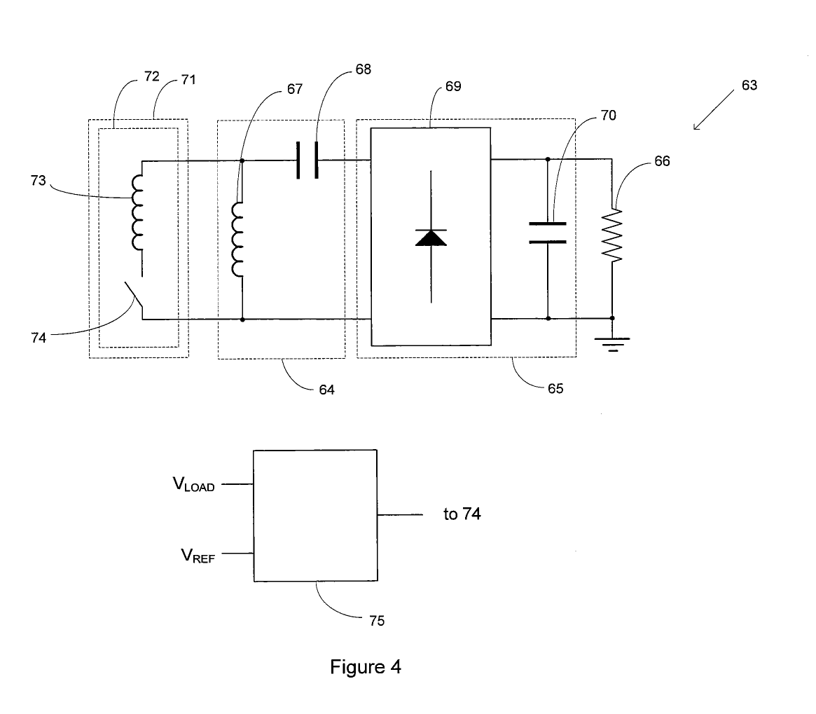

In the embodiment of the inductive power receiver 15 discussed above in relation to FIG. 2, the damping element 23 includes a variable capacitance 24. However, in another embodiment, the damping element may include a variable inductance. FIG. 4 shows another embodiment of an inductive power receiver 63. The inductive power receiver includes a resonant circuit 64 connected to power conditioning circuitry 65. The conditioning circuitry is further connected to a load 66 which is illustrated as a resistive element to depict the electrical nature of the load.

The resonant circuit 64 includes one or more receiving coils 67 connected with a resonating capacitor 68. In FIG. 4, the receiving coil is connected in series with the resonating capacitor. However, in other embodiments, it may be possible for the receiving coil to be connected in parallel with the resonating capacitor. In one embodiment, the resonant circuit is configured to have a resonant frequency that corresponds to the frequency of the power transmitted by the inductive power transmitter. In a preferred embodiment, the resonant circuit is configured to have a resonant frequency such that under relatively poor coupling conditions, sufficient power is still provided to the load 66.

The conditioning circuitry 65 provides power from the resonant circuit 64 to the load 66. In the illustrated embodiment, the conditioning circuitry may include a diode bridge rectifier 69 and a DC smoothing capacitor 70.

The inductive power receiver also includes a damping element 71. In this embodiment, the damping element 71 includes a variable inductance 72 connected in parallel with the receiving coil 67. The variable inductance includes a damping inductor 73 connected in series with a variable impedance 74. The inductance of the damping inductor is selected so that the range of inductances provided by the variable inductance allows an inductance of at least twice the inductance of the receiving coil 67. In a preferred embodiment, the range of the variable inductance allows an inductance between five to ten times the inductance of the receiving coil, as an inductance higher than this causes the rise time of the power signal delivered to the load to increase thereby undesirably delaying power delivery. As will be explained in more detail later, selecting the inductance of the damping inductor to be larger than that of the receiving coil allows the inductive power receiver 63 to regulate the power to the load 66 over a relatively large range of power values.

The variable impedance 74 is controlled by a control circuit 75. The variable impedance may be any suitable element or device with an impedance that may be varied. In FIG. 4, the variable impedance is represented generally by a switch. The variable impedance may be a semiconductor device such as a transistor, for example a BJT or a MOSFET. Those skilled in the art will appreciate how the topology of FIG. 4 may need to be configured to operate with various applicable types of variable impedances (for example, due to the polarity of the transistor), accordingly, in FIG. 4 the control circuit 75 is depicted without direct connection to the variable impedance 74, as the invention is not limited in this respect.

The control circuit 75 controls the variable impedance 74 so as to vary the impedance, thus controlling the effective inductance of the variable inductance 72. The variable impedance is preferably controlled in linear mode (i.e. in an Ohmic region of operation) resulting in a continuous range of impedances. In another embodiment, the variable impedance may be controlled in either ‘hard’ or ‘soft’ switch mode (such that the variable impedance is either fully on or fully off (with various degrees of control on the transition there between), with the respective proportion of time the variable impedance is in either of these states being controlled so as to give a range of effective impedances.

The control circuit 75, which is represented by a block in FIG. 4, is configured to provide a control signal to control the variable impedance. The controller has inputs, for example VREF and VLOAD from which the control signal is derived. A specific embodiment of the control circuit and the manner in which the control signal is provided will be discussed later with reference to FIG. 6.

Having generally discussed the components of FIG. 4, it is helpful to consider an exemplary operation of the inductive power receiver 63 with respect to the power flow control to the load 66. As discussed earlier, the resonant circuit 64 may be configured to pick up sufficient power for the particular load despite relatively poor coupling between the receiving coil(s) 67 and the transmitting coil(s). For example, the system 1 of the present invention is configured so that sufficient power is provided if the coupling between the receiving coil(s) and transmitting coil(s) has a coupling coefficient, k, less than 0.5, and even less than 0.1, e.g., about 0.08. Such poor coupling may be due to misalignment of the coils or non-ideal distance between the coils. This is achieved by suitable selection of the values of the components of the receiver, e.g., the inductive value of the receiving coil(s) and the capacitance value of the resonating capacitor, relative to the transmitted power value at the coupling coefficient deemed as the minimum coupling coefficient to be supported by the system and the power required by the receiver side load, and then controlling the variable impedance 74 to be fully switched off by default, so that the variable inductance 72 has no effect on the power picked up by the resonant circuit, and therefore no effect on the power provided to the load 66, when there is poor coupling.

If the coupling is caused to improve (for example, due to the distance between the receiving and transmitting coils being brought closer to ideal), the amount of power picked up by the resonant circuit 64 increases. If the default state of the damping element is maintained in this improved coupling condition excessive power will be received by the receiver which will result in either too much power being provided to the load or the excess power being dissipated by the receiver circuitry in the form of heat. This is circumvented by configuring the control circuit 75 to detect this increase in received power and control the variable impedance 74 to be switched on, either immediately or gradually, which introduces the impedance presented by the variable impedance into the circuit. This introduces the effective inductance of the variable inductance 72 into the circuit which dampens the resonant circuit 64 so that it picks up less power thereby regulating the amount of power delivered to the load. Effectively, the variable inductance detunes the resonant circuit, and the amount of detuning is controlled by the value of the variable inductance.

Accordingly, if the degree of coupling is increased further to ideal (e.g., the distance between the receiving and transmitting coils is brought to zero), the control circuit is able to control the switching of the variable impedance so as to increase the effective inductance of the variable inductance to maximally dampen the resonant circuit based on the achievable inductance value of the variable inductance. Depending upon the specific application, the range of couplings supported by the system may be required to be maximised, i.e., from poorest to ideal coupling, however a lesser range can be provided whilst still providing enhanced operation and capabilities. For example, by selecting a damping inductor with an inductance that is at least twice the inductance of the receiving coil, the variable inductance is able to be varied over a relatively large range and consequently dampen the resonant circuit over a relatively large range of couplings. An exemplary configuration of the control circuit which provides these functions of detection and control is discussed in detail later with reference to FIG. 6.

In the embodiment of the inductive power receiver discussed in relation to FIG. 4, the damping element 71 includes a single variable inductance connected in parallel with the receiving coil 67. However, those skilled in the art will appreciate that it may be possible to configure the damping element to include more than one variable inductance and/or to connect each variable inductance across different points of the resonant circuit.

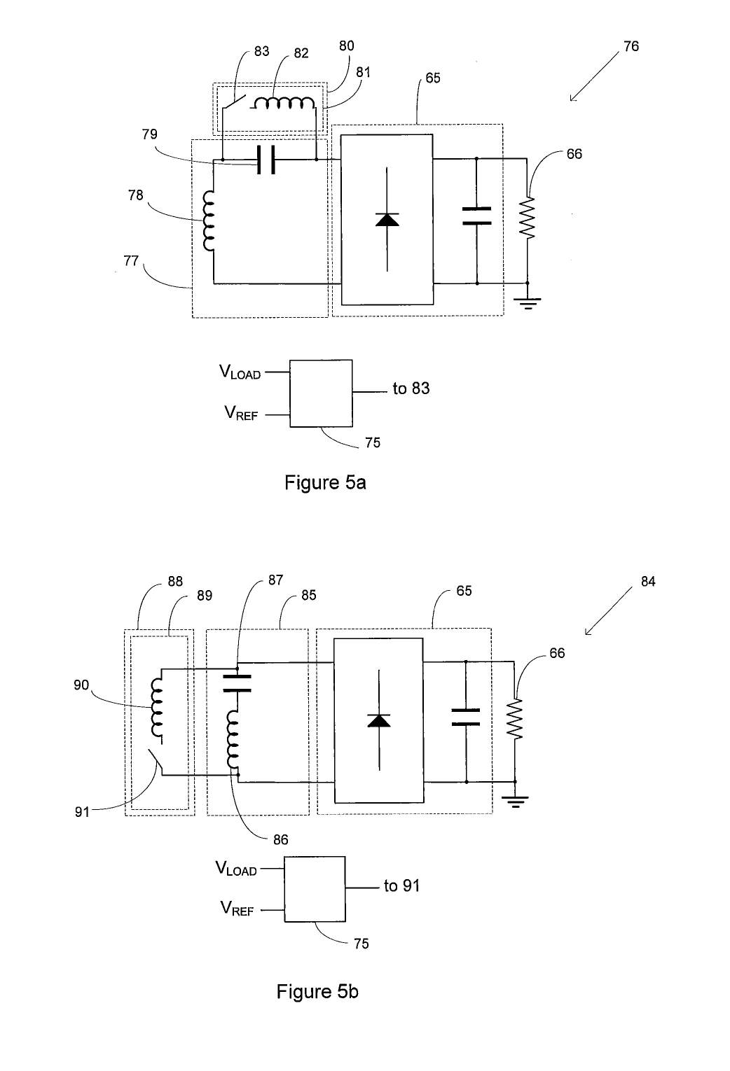

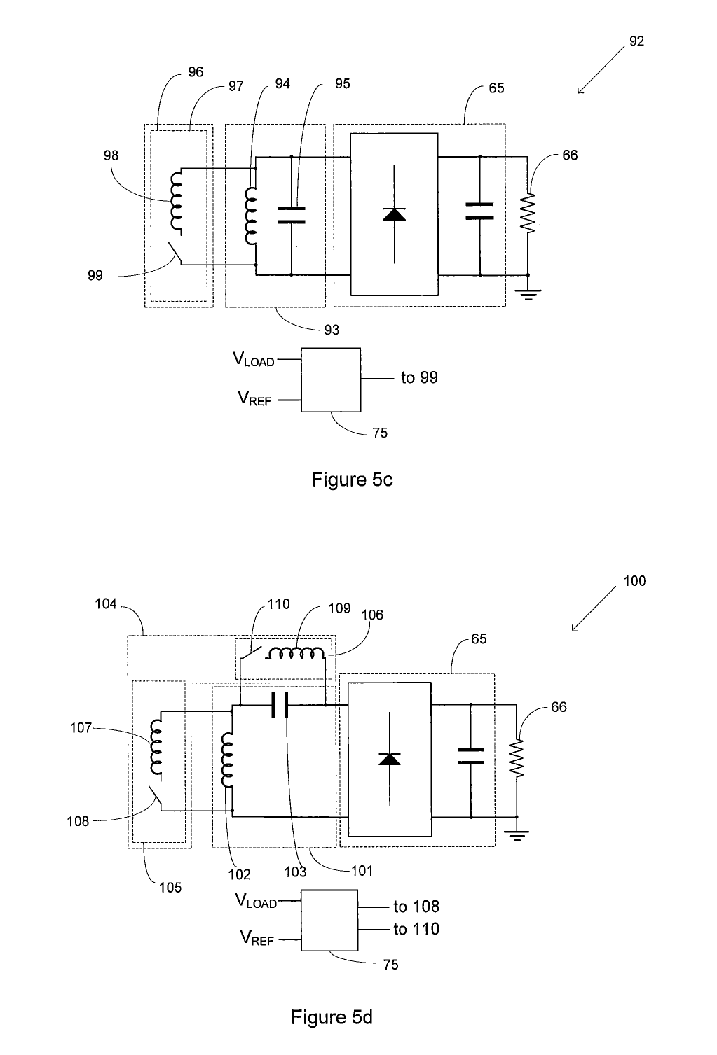

FIGS. 5a to 5d show some possible variations of the inductive power receiver 63 discussed in relation to FIG. 4. For the sake of comparison, the conditioning circuitry 65, load 66 and control circuit 75 have not been changed between each embodiment. Those skilled in the art will appreciate how the discussion of FIG. 4 may be adapted to relate to the topologies of FIGS. 5a to 5d.

In FIG. 5a, the inductive power receiver 76 includes a resonant circuit 77 having a receiving coil 78 connected in series with a resonating capacitor 79. A damping element 80 includes a variable inductance 81 connected in parallel with the resonating capacitor. The variable inductance includes a damping inductor 82 connected in series with a variable impedance 83. The inductance of the damping inductor 82 is at least twice the inductance of the receiving coil. In a preferred embodiment, the inductance of the damping inductor is between five and ten times the inductance of the receiving coil.

In FIG. 5b, the inductive power receiver 84 includes a resonant circuit 85 having a receiving coil 86 connected in series with a resonating capacitor 87. A damping element 88 includes a variable inductance 89 connected in parallel with the receiving coil and resonating capacitor. The variable inductance includes a damping inductor 90 connected in series with a variable impedance 91. The inductance of the damping inductor 90 is at least twice the inductance of the receiving coil. In a preferred embodiment, the inductance of the damping inductor is between five and ten times the inductance of the receiving coil.

In FIG. 5c, the inductive power receiver 92 includes a resonant circuit 93 having a receiving coil 94 connected in parallel with a resonating capacitor 95. A damping element 96 includes a variable inductance 97 connected in parallel with the receiving coil and resonating capacitor. The variable inductance includes a damping inductor 98 connected in series with a variable impedance 99. The inductance of the damping inductor is at least twice the inductance of the receiving coil. In a preferred embodiment, the inductance of the damping inductor is between five and ten times the inductance of the receiving coil.

In FIG. 5d, the inductive power receiver 100 includes a resonant circuit 101 having a receiving coil 102 connected in series with a resonating capacitor 103. A damping element 104 includes a first variable inductance 104 connected in parallel with the receiving coil and a second variable inductance 106 connected in parallel with the resonating capacitor. The first variable inductance includes a first damping inductor 107 connected in series with a first variable impedance 108. The second variable inductance includes a first damping inductor 109 connected in series with a second variable impedance 110. The inductance of the first damping inductor and second damping inductor is at least twice the inductance of the receiving coil. In a preferred embodiment, the inductance of the first damping inductor and second damping inductor is between five and ten times the inductance of the receiving coil.

It will be appreciated from the foregoing discussion of FIGS. 2 to 5d, that it may further be possible to include both variable inductances and variable capacitances.

FIG. 6 shows a topology of another embodiment of the inductive power receiver discussed generally in relation to FIG. 2. The inductive power receiver 111 includes a resonant circuit 112 connected to power conditioning circuitry 113. The conditioning circuitry is further connected to a load 114.

The resonant circuit 111 includes one or more receiving coil(s) 115 connected in series with a resonating capacitor 116. In one embodiment, the resonant circuit is configured to have a resonant frequency that corresponds to the frequency of the power transmitted by the inductive power transmitter. In a preferred embodiment, the resonant circuit is configured to have a resonant frequency such that under relatively poor coupling conditions, sufficient power is still provided to the load 114.

The conditioning circuitry 113 provides power from the resonant circuit 112 to the load 114. The conditioning circuitry includes a rectifier 117 and a DC smoothing capacitor 118. The rectifier rectifies the AC power picked up by the resonant circuit to a DC power that is provided to the load. The DC smoothing capacitor smooths the current provided to the load. In this embodiment, the rectifier, resonating capacitor 116 and DC smoothing capacitor 118 act together as a voltage doubler.

The inductive power receiver also includes a damping element in the form of a variable capacitance 119 connected in parallel with the receiving coil 115. The variable capacitance includes a damping capacitor 120 connected in series with a first variable impedance 121. The capacitance of the damping capacitor is selected so that the range of capacitances provided by the variable capacitance allows a capacitance of at least twice the capacitance of the resonating capacitor 116. In a preferred embodiment, the range of the variable capacitance allows a capacitance between five to ten times the capacitance of the resonating capacitor.

The first variable impedance 121 is connected to a control circuit 122. The first variable impedance is shown as an n-channel MOSFET having the gate 123 connected to the control circuit. Those skilled in the art will appreciate how the topology of FIG. 6 may need to be configured to operate with the various applicable types of variable impedances (for example, due to the polarity of the transistor) and the invention is not limited in this respect.

The control circuit 122 controls the first variable impedance 121 so as to vary the impedance, thus controlling the effective capacitance of the variable capacitance 119. The first variable impedance is preferably controlled in linear mode (i.e. in an Ohmic region of operation) resulting in a continuous range of impedances. In another embodiment, the first variable impedance may be controlled in either ‘hard’ or ‘soft’ switch mode such that the variable impedance is either fully on or fully off (with various degrees of control on the transition there between), with the respective proportion of time the first variable impedance is in either of these states being controlled so as to give a range of effective impedances.

The control circuit 122 includes a second variable impedance 124, represented in the topology of FIG. 6 by a PNP BJT. An output 125 of the second variable impedance provides a control signal that controls the first variable impedance 121. In the topology of FIG. 6, the output 125 is from the collector of the BJT 124, which in turn is connected to the gate 123 of the first variable impedance 121. The output is connected to the gate via a gate resistor 126. The purpose of the gate resistor is to control the rise time of the voltage supplied to the gate 123. There may also be an additional smoothing capacitor 127 to smooth the control signal that controls the first variable impedance 121.

The control signal provided by the output 125 of the second variable impedance 124 is based on a load voltage input 128 (VLOAD of FIGS. 2 to 5d) and a reference voltage input 129 (VREF of FIGS. 2 to 5d). In the topology of FIG. 6, the load voltage input is connected to the load 114 and the emitter of the BJT 124. The reference voltage input provides a reference voltage to control the operation of the second variable impedance. In the topology of FIG. 6, the reference voltage input is connected to the base of the BJT 124. As will be described in more detail below, when the load voltage exceeds some threshold voltage, current will flow through the second variable impedance, and thus the first variable impedance will turn on. It will be appreciated that the second variable impedance may be controlled in linear mode, which will in turn effect linear mode control of the first variable impedance.

The reference voltage input 129 may be provided by a zener diode 130 having a suitable breakdown voltage. This breakdown voltage may be configured so that the second variable impedance turns on when the load voltage input 128 exceeds a threshold voltage. For example, the zener diode may be rated with a breakdown voltage of about 4.2 V, fixing the reference voltage at about 4.2 V. Thus, when the load voltage exceeds a threshold voltage of approximately 4.9 V (being the reference voltage, about 4.2 V, and the emitter-base voltage of the BJT, about 0.7 V), the second variable impedance turns on. Current is fed to the zener diode from the resonant circuit 112 by a further diode 131. There may also be a filtering resistor 132 and filtering capacitor 133, which serve to filter the reference voltage.

Having generally discussed the components of FIG. 6, it is helpful to consider an exemplary operation of the inductive power receiver 111. The resonant circuit 112 may be configured to pick up sufficient power for the particular load 114 despite relatively poor coupling conditions between the receiving coil 114 and the transmitting coil(s). For example, the system 1 of the present invention is configured so that sufficient power is provided if the coupling between the receiving coil and transmitting coil(s) has a coupling coefficient, k, less than 0.5, and even less than 0.1, e.g., about 0.08. Such poor coupling may be due to misalignment of the coils or non-ideal distance between the coils. In this present embodiment, the power provided to the load is sufficient when the load voltage input 128 equals the threshold voltage (being the reference voltage input 129 and any internal voltage in the second variable impedance 124). For example, the load voltage may be 4.9 V with the zener component selected so as to have a suitable breakdown voltage of 4.2 V. Therefore, the second variable impedance 124 will be off, so no current is supplied to the output 125 and the gate 123 of the first variable impedance 121. This means the first variable impedance is also off, so that the variable capacitance 119 has no effect on the power picked up by the resonant circuit, and therefore no effect on the power provided to the load 114, when there is poor coupling.

In one example, if the amount of power required by the load is about 100 mW and this amount of power is to be delivered to the load when the coupling coefficient is less than 0.1, selecting an inductance value of the receiving coil of about 74 microH and a capacitance value of the resonating capacitor of about 14 nanoF ensures that sufficient power is provided to the load. Further, this delivery of required power is maintained without undue delay in power delivery as the coupling improves by selecting a capacitance value of the damping capacitor of about 100 nanoF.

Upon the coupling improving (for example, due to the distance between the receiving coil 114 and transmitting coil(s) being brought closer to ideal), the amount of power picked up by the resonant circuit 112 increases. This results in an increase in the voltage across the load 114. The load voltage output 128 will therefore exceed the threshold voltage, and the second variable impedance 124 will turn on in linear mode. Therefore, current will flow from the output 125 to the gate 123 of the first variable impedance 121. The first variable impedance will therefore turn on in linear mode, decreasing in impedance. In turn, this increases the effective capacitance of the variable capacitance 119. The variable capacitance dampens the resonant circuit 112 so that it picks up less power. Since less power is picked up, less power is provided to the load, and thus the power provided to the load is regulated until it falls below the threshold voltage. It will be appreciated the load voltage 128 will then oscillate about the threshold voltage, as the second variable impedance is sequentially turned off and on.

As the degree of coupling is increased further, the amount of power picked up by the resonant circuit 112 further increases. This results in a further increase in the voltage across the load 114. The second variable impedance 124 will turn on in linear mode. Therefore, more current will flow from the output 125 to the gate 123 of the first variable impedance 121. The first variable impedance will therefore turn on in linear mode, further decreasing in impedance. In turn, this further increases the effective capacitance of the variable capacitance 119. The variable capacitance dampens the resonant circuit 112 so that it picks up less power. Since less power is picked up, less power is provided to the load, and thus the power provided to the load is regulated until it falls below the threshold voltage. It will be appreciated the load voltage 128 will then oscillate about the threshold voltage, as the second variable impedance is sequentially turned off and on.

It will be appreciated from the discussion above that the control circuit 122 is able to control the first variable impedance 121 so as to control its impedance and thus regulate the power provided to the load 128. A benefit of the control circuit is that it does not include any components that drain a large amount of power, such as controllers or ICs. Therefore, the quiescent losses of the control circuit are minimal. This is particularly advantageous for inductive power receivers in low power IPT systems, where the tolerances for power losses are relatively small.

Though the control circuit 122 discussed in relation to FIG. 6 corresponded to a specific embodiment of FIG. 2, those skilled in the art will appreciate how it may be configured to work with any other embodiment of inductive power receiver of the present invention. This includes those embodiments discussed in relation to FIGS. 2 to 5d. In a further possible embodiment, the first variable impedance controlled by the control circuit may be connected in series with at least one of the receiving coil and the resonating capacitor.

The term “coil” as used herein is generally provided to define an inductive winding, but those skilled in the art understand that this is not the only configuration applicable to provide the features and advantages of the present invention. For example, the term “coil” may define any arbitrary three-dimensional coil-shaped configurations as well as two-dimensional coil-shaped configurations. Further, the term “coil” may define non-coil shaped configurations. Furthermore, the term “coil” may define configurations that are formed from physically or mechanically wound windings of wire, such as Copper or Litz wire, that are printed using conductive material, such as using printed circuit board methods, and that are formed by other suitable methods.

Those skilled in the art understand that the various embodiments described herein and claimed in the appended claims provide a utilisable invention and at least provide the public with a useful choice.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1.-40. (canceled)

41. The inductive power receiver as claimed in claim 46, wherein the first variable impedance is a semiconductor device.

42. The inductive power receiver as claimed in claim 46, wherein the first variable impedance is a transistor.

43. The inductive power receiver as claimed in claim 46, wherein the first variable impedance is controlled in linear mode.

44. The inductive power receiver as claimed in claim 54, wherein the capacitance of the damping capacitor at least twice the capacitance of the first capacitor or is between five and ten times the capacitance of the first capacitor.

45. The inductive power receiver as claimed in claim 54, wherein the inductance of the damping inductor is at least twice the inductance of the receiving coil or between five and ten times the inductance of the receiving coil.

46. An inductive power receiver including:
a. a resonant circuit having a receiving coil and a capacitor;
b. power conditioning circuitry for providing power from the resonant circuit to a load;
c. a damping element connected in parallel or series with at least one of the receiving coil and the capacitor, wherein the damping element includes a first variable impedance; and
d. a control circuit for controlling the first variable impedance so as to regulate the power provided to the load,
and wherein the control circuit is switched off by default and only switches on when a load voltage is above a threshold.

47. The inductive power receiver as claimed in claim 46, wherein the second variable impedance is a semiconductor device.

48. The inductive power receiver as claimed in claim 46, wherein the second variable impedance is a transistor.

49. The inductive power receiver as claimed in claim 48, wherein the second variable impedance is a bipolar junction transistor with:
a. the emitter of the bipolar junction transistor connected to the load voltage;
b. the base of the bipolar junction transistor is connected to the reference voltage; and
c. the collector of the bipolar junction transistor is connected to the first variable impedance.

50. The inductive power receiver as claimed in claim 46, wherein the reference voltage input is a zener diode with a suitable break down voltage.

51. The inductive power receiver as claimed in claim 46, wherein the first variable impedance is a semiconductor device.

52. The inductive power receiver as claimed in claim 46, wherein the first variable impedance is a transistor.

53. The inductive power receiver as claimed in claim 46, wherein the first variable impedance is controlled in linear mode.

54. The inductive power receiver as claimed in claim 46, wherein the damping element includes at least one of: a damping capacitor and a damping inductor.

55. The inductive power receiver as claimed in claim 54, wherein the damping inductor is connected in parallel or series with the first variable impedance.

56. The inductive power receiver as claimed in claim 54, wherein the damping capacitor is connected in parallel or series with the first variable impedance.

57. The inductive power receiver as claimed in claim 46, wherein the power conditioning circuitry includes a rectifier.

58. The inductive power receiver as claimed in claim 46, wherein the control circuit includes a second variable impedance that provides a control signal output for controlling the first variable impedance based on a load voltage input and a reference voltage input.
